(19) United States
(12) Patent Application Publication
(10) Pub. No.: US 2025/0119047 A1
(43) Pub. Date: Apr. 10, 2025

(54) POWER TRANSMISSION DEVICE AND EXPANSION VALVE

(71) Applicant: DENSO CORPORATION, Kariya-city (JP)

(72) Inventors: Takafumi MATSUMOTO, Kariya-city (JP); Hiroto INOUE, Kariya-city (JP); Takuro SAHARA, Kariya-city (JP); Shinji HASHIMOTO, Kariya-city (JP); Satoshi MIYANO, Kariya-city (JP); Riku OUCHI, Kariya-city (JP); Shigeji OISHI, Kariya-city (JP); Hiroyuki KAWASHIMA, Kariya-city (JP); Tokuhisa TAKEUCHI, Kariya-city (JP)

(21) Appl. No.: 18/983,205

(22) Filed: Dec. 16, 2024

Related U.S. Application Data
(63) Continuation of application No. PCT/JP2023/021886, filed on Jun. 13, 2023.

(30) Foreign Application Priority Data
Jun. 28, 2022 (JP) 2022-103445

(51) Int. Cl. H02K 49/10

(52) U.S. Cl. CPC H02K 49/102

(57) ABSTRACT

A power transmission device includes a magnetic gear with an input shaft magnet that receives rotational driving force, a magnetic modulator to modulate magnetic flux, a multi-pole magnet with more poles than the input shaft magnet, and an output shaft rotating with either the magnetic modulator or the multi-pole magnet. The device also features a magnetic circuit where the magnetic flux flows in parallel from the input shaft magnet. Between the input shaft magnet and the magnetic modulator is a flux-forming member with higher magnetic permeability than a vacuum, forming a short-circuiting flux path. The magnetic circuit creates two paths: a torque generation path, where magnetic flux flows through the magnetic modulator and multi-pole magnet, and a short-circuit flux path, where it bypasses the magnetic modulator. The flux-forming member's magnetic permeability is within ±20% of the value that maximizes torque.

### CROSS REFERENCE TO RELATED APPLICATION

The present application is a continuation application of International Patent Application No. PCT/JP2023/021886 filed on Jun. 13, 2023, which designated the U.S. and claims the benefit of priority from Japanese Patent Application No. 2022-103445 filed on Jun. 28, 2022. The entire disclosures of all of the above applications are incorporated herein by reference.

### TECHNICAL FIELD

The present disclosure relates to a power transmission device having a magnetic gear that transmits power using magnetic force.

### BACKGROUND

A power transmission device has a cylindrical first mover and a second mover arranged coaxially with each other, and a cylindrical intermediate yoke arranged between the first mover and the second mover.

### SUMMARY

According to at least one embodiment, a power transmission device has a magnetic gear and a magnetic circuit. The magnetic gear has an input shaft magnet, a magnetic modulator, a multi-pole magnet, and an output shaft.

Rotational driving force is input to the input shaft magnet. The magnetic modulator modulates a magnetic flux. The multi-pole magnet has more poles than the input shaft magnet. The output shaft rotates in unison with the magnetic modulator or the multi-pole magnet.

The magnetic flux from the input shaft magnet flows in parallel in the magnetic circuit. The magnetic circuit forms a torque generation path and a short-circuit flux path. Between the input shaft magnet and the magnetic modulator is a flux-forming member. This member has a higher magnetic permeability than a vacuum and forms a short-circuiting flux path. The magnetic circuit forms two paths: a torque generation path and a short-circuit flux path. In the torque generation path, a magnetic flux flows from an N pole of the input shaft magnet through the magnetic modulator and the multi-pole magnet to an S pole of the input shaft magnet to generate torque. In the short-circuit flux path, a magnetic flux flows short-circuiting from the N pole of the input shaft magnet to the S pole of the input shaft magnet without passing through the magnetic modulator. The magnetic permeability of the flux-forming member is within ±20% of the magnetic permeability at which torque is maximized.

### BRIEF DESCRIPTION OF DRAWINGS

The details of one or more embodiments are set forth in the accompanying drawings and the description below. Other features and advantages will be apparent from the description and drawings, and from the claims.

The foregoing and other objects, features, and advantages of the present disclosure will become more apparent from the following detailed description with reference to the accompanying drawings.

FIG. 1 is an overall configuration diagram of a vehicle air-conditioning device according to a first embodiment.

FIG. 2 is a cross-sectional view illustrating a first expansion valve of the first embodiment.

FIG. 3 is a cross-sectional view taken along a line III-III of FIG. 2.

FIG. 4 is a block diagram illustrating a controller of the vehicle air-conditioning device according to the first embodiment.

FIG. 5 is a circuit diagram illustrating a magnetic circuit formed by a magnetic gear of the first embodiment.

FIG. 6 shows a relationship between magnetic permeability and transmission torque in the magnetic gear of the first embodiment.

FIG. 7 is a cross-sectional view illustrating the magnetic gear of a second embodiment.

FIG. 8 is an exploded perspective view illustrating a magnetic gear of a third embodiment.

FIG. 9 is a cross-sectional view illustrating a magnetic gear of a fourth embodiment.

### DETAILED DESCRIPTION

To begin with, examples of relevant techniques will be described.

A power transmission according to a comparative example has a cylindrical first mover and a second mover arranged coaxially with each other, and a cylindrical intermediate yoke arranged between the first mover and the second mover.

The first and second mover have a predetermined number of pole pairs along a circumferential direction. The intermediate yoke has magnetic elements along the circumferential direction. The number of magnetic elements in the intermediate yoke is equal to the sum of the number of magnetic pole pairs in the first mover and the number of magnetic pole pairs in the second mover.

When one of the first and second mover rotates, magnetic interaction between the first mover's magnetic pole pair and the second mover's magnetic pole pair causes the other mover to rotate. In other words, power is transmitted by torque generated between the first and second mover and the intermediate yoke.

In the power transmission device with magnetic gears, it is preferable to maximize transmission torque by effectively using magnetic force of first and second movers.

In contrast to the comparative example, according to a a power transmission device of the present disclosure, transmission torque can be improved.

According to one aspect of the present disclosure, a power transmission device has a magnetic gear and a magnetic circuit. The magnetic gear has an input shaft magnet, a magnetic modulator, a multi-pole magnet, and an output shaft.

Rotational driving force is input to the input shaft magnet. The magnetic modulator modulates a magnetic flux. The multi-pole magnet has more poles than the input shaft magnet. The output shaft rotates in unison with the magnetic modulator or the multi-pole magnet.

The magnetic flux from the input shaft magnet flows in parallel in the magnetic circuit. Between the input shaft magnet and the magnetic modulator is a flux-forming member. This member has a higher magnetic permeability than a vacuum and forms a short-circuiting flux path. The magnetic circuit forms a torque generation path and a short-circuit flux path. In the torque generation path, a magnetic flux flows from an N pole of the input shaft magnet through the magnetic modulator and the multi-pole magnet to an S pole of the input shaft magnet to generate torque. In the short-circuit flux path, a magnetic flux flows short-circuiting from the N pole of the input shaft magnet to the S pole of the input shaft magnet without passing through the magnetic modulator. The magnetic permeability of the flux-forming member is within ±20% of the magnetic permeability at which torque is maximized.

According to this configuration, the magnetic flux flowing through the torque generation path can be increased by forming the short-circuit flux path. This makes it possible to improve the transmission torque.

Hereinafter, embodiments for implementing the present disclosure will be described referring to drawings. In each embodiment, portions corresponding to those described in the preceding embodiment are denoted by the same reference numerals, and overlapping descriptions may be omitted. In a case where only a part of the configuration is described in each embodiment, other embodiments previously described can be applied to other parts of the configuration. It is also possible to partially combine the embodiments even when it is not explicitly described, as long as there is no problem in the combination as well as the combination of the parts specifically and explicitly described that the combination is possible.

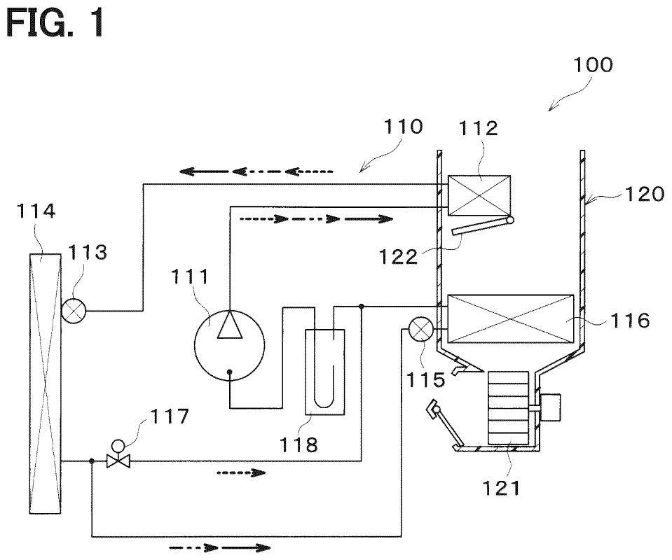

A first embodiment of the present disclosure will be described with reference to FIGS. 1 to 7. A power transmission device 1 of the present embodiment is applied to a first expansion valve 113 and a second expansion valve 115 of a vapor compression refrigeration cycle 110. The expansion valves 113, 115 are an example of a motor-operated valve or a solenoid valve. The vapor compression refrigeration cycle 110 is applied to a vehicle air-conditioning device 100 shown in FIG. 1. The vehicle air-conditioning device 100 for vehicles is applied to an electric vehicle that obtains its driving power for vehicle running from an electric motor for driving.

The vehicle air-conditioning device 100 has three operating modes: a cooling mode for cooling a vehicle compartment in the vehicle; a heating mode for heating the vehicle compartment; and a dehumidifying-heating mode for heating and dehumidifying the vehicle compartment. In FIG. 1, refrigerant flow in the cooling mode is indicated by solid arrows, refrigerant flow in the heating mode is indicated by dashed arrows, and refrigerant flow in the dehumidifying-heating mode is indicated by two-dot chain arrows.

The vehicle air-conditioning device 100 includes the vapor compression refrigeration cycle 110 and an air conditioning unit 120 for the vehicle compartment.

The vapor compression refrigeration cycle 110 includes a compressor 111, an indoor heat exchanger 112, the first expansion valve 113, an outdoor heat exchanger 114, the second expansion valve 115, an evaporator 116, a solenoid valve 117, and an accumulator 118.

The compressor 111 is an electric compressor that draws, compresses, and discharges refrigerant. The vapor compression refrigeration cycle 110 is a subcritical cycle in which a high refrigerant pressure does not exceed the critical pressure of the refrigerant, and a CFC refrigerant (for example, R134a) is used as the refrigerant circulating in the vapor compression refrigeration cycle 110.

The indoor heat exchanger 112 condenses the refrigerant discharged from the compressor 111 by heat exchange with air flowing in the air conditioning unit 120. The first expansion valve 113 decompresses and expands the refrigerant condensed in the indoor heat exchanger 112. The outdoor heat exchanger 114 exchanges heat between the refrigerant discharged from the first expansion valve 113 and outside air.

The second expansion valve 115 decompresses and expands the refrigerant flowing out of the outdoor heat exchanger 114. The evaporator 116 evaporates the refrigerant decompressed and expanded by the second expansion valve 115 by heat exchange with the air flowing in the air conditioning unit 120.

The solenoid valve 117 opens and closes a refrigerant flow path leading the refrigerant flowing out of the outdoor heat exchanger 114 to the accumulator 118 bypassing the second expansion valve 115 and the evaporator 116. The accumulator 118 separates a gas-liquid of the refrigerant that has evaporated in the evaporator 116 and the refrigerant that has passed through the solenoid valve 117.

The air conditioning unit 120 is located in the vehicle compartment and forms an air passage within the air conditioning unit 120. A blower 121, the evaporator 116, the indoor heat exchanger 112, and an air mix door 122 are located in the air passage in the air conditioning unit 120.

The blower 121 is an electric blower that blows air into the air passage in the air conditioning unit 120. The evaporator 116 is located downstream of the airflow relative to the blower 121. The indoor heat exchanger 112 is located downstream of the airflow relative to the evaporator 116. The air mix door 122 regulates a flow ratio between the air flowing to the indoor heat exchanger 112 and the air bypassing the indoor heat exchanger 112. The air conditioning unit 120 blows air conditioned by the air mix door 122 into the vehicle compartment.

In the cooling mode of the vehicle air-conditioning device 100, the solenoid valve 117 is closed and the air mix door 122 closes the air passage to the indoor heat exchanger 112. Therefore, the refrigerant discharged from the compressor 111 passes through the indoor heat exchanger 112 without heat exchange in the indoor heat exchanger 112, and flows in the following order: the first expansion valve 113, the outdoor heat exchanger 114, the second expansion valve 115, the evaporator 116, the accumulator 118, and returns to the compressor 111 from the accumulator 118.

At this time, the first expansion valve 113 is set to a fully opening degree at which the flow of the refrigerant is not reduced, and the second expansion valve 115 is set to a valve opening degree at which the flow of the refrigerant is reduced, and therefore the refrigerant is condensed in the outdoor heat exchanger 114 and the refrigerant is vaporized in the evaporator 116.

In the heating mode of the vehicle air-conditioning device 100, the solenoid valve 117 is set to open, the second expansion valve 115 is set to close to shut off refrigerant flow, and the air mix door 122 is opened to allow air to circulate to the indoor heat exchanger 112. Therefore, the refrigerant discharged from the compressor 111 flows in the following order: the indoor heat exchanger 112, the first expansion valve 113, the outdoor heat exchanger 114, the solenoid valve 117, and the accumulator 118, and returns to the compressor 111 from the accumulator 118. At this time, the first expansion valve 113 is set to a valve open degree to restrict the refrigerant flow, and the second expansion valve 115 is closed, so that the refrigerant is condensed in the indoor heat exchanger 112, the refrigerant is evaporated in the outdoor heat exchanger 114, and no refrigerant flows into the evaporator 116.

In the dehumidifying-heating mode of the vehicle air-conditioning device 100, the solenoid valve 117 is closed and the air mix door 122 is opened so that the air is distributed to the indoor heat exchanger 112. Therefore, the refrigerant discharged from the compressor 111 flows in the following order: the indoor heat exchanger 112, the first expansion valve 113, the outdoor heat exchanger 114, the second expansion valve 115, the evaporator 116, the accumulator 118, and returns to the compressor 111 from the accumulator 118.

At this time, the first expansion valve 113 and the second expansion valve 115 are set to valve openings that restrict refrigerant flow, so that the refrigerant is condensed in the indoor heat exchanger 112 and evaporated in the outdoor heat exchanger 114 and the evaporator 116.

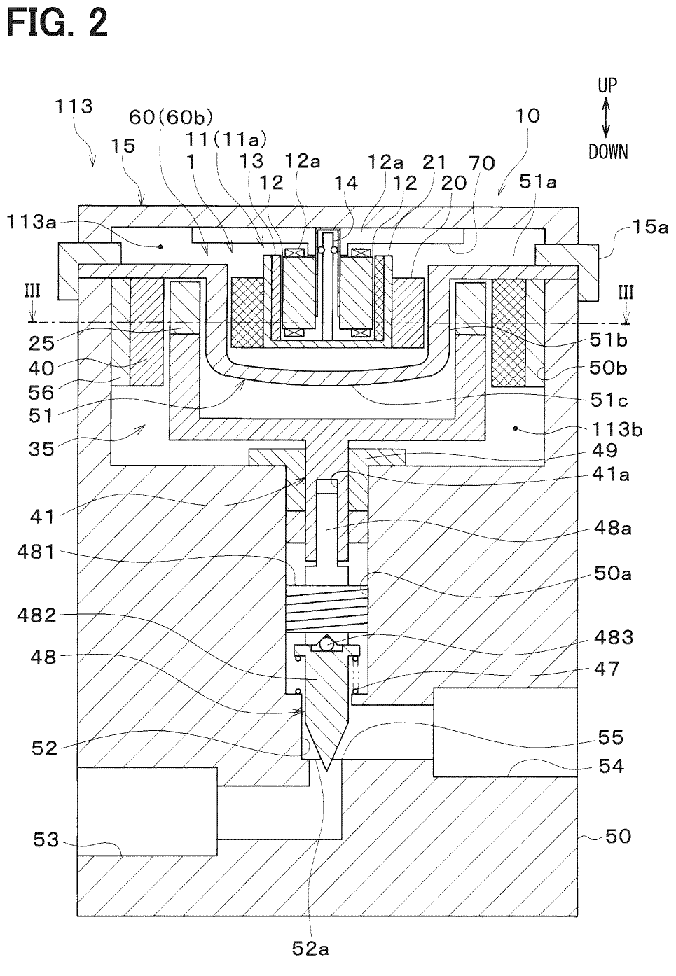

As shown in FIG. 2, the first expansion valve 113 has the power transmission device 1, a drive-mechanism section 10, and a driven-mechanism section 35. The first expansion valve 113 is positioned vertically in the vehicle. The vertical arrangement is an arrangement in which an axial direction of a valve body 48 is parallel to a up-down direction of the vehicle and the drive-mechanism section 10 is on an upper side of the vehicle relative to the driven-mechanism section 35.

The power transmission device 1 transmits driving power generated by the drive-mechanism section 10 to the driven-mechanism section 35 using magnetic force.

The drive-mechanism section 10 has a motor 11 and a motor case 15. The motor 11 can be driven by speed feedback control and has a stator 12, a rotor 13, and a shaft 14. The motor 11 is, for example, a three-phase brushless motor or a DC brush motor.

The shaft 14 is an output shaft of the motor 11 and an input shaft of the power transmission device 1, and rotates together with the rotor 13. The motor case 15 houses the motor 11.

The stator 12 is fixed to the motor case 15. The stator 12 includes a stator coil 12a. In the present embodiment, the number of slots Ns in the stator 12 is six.

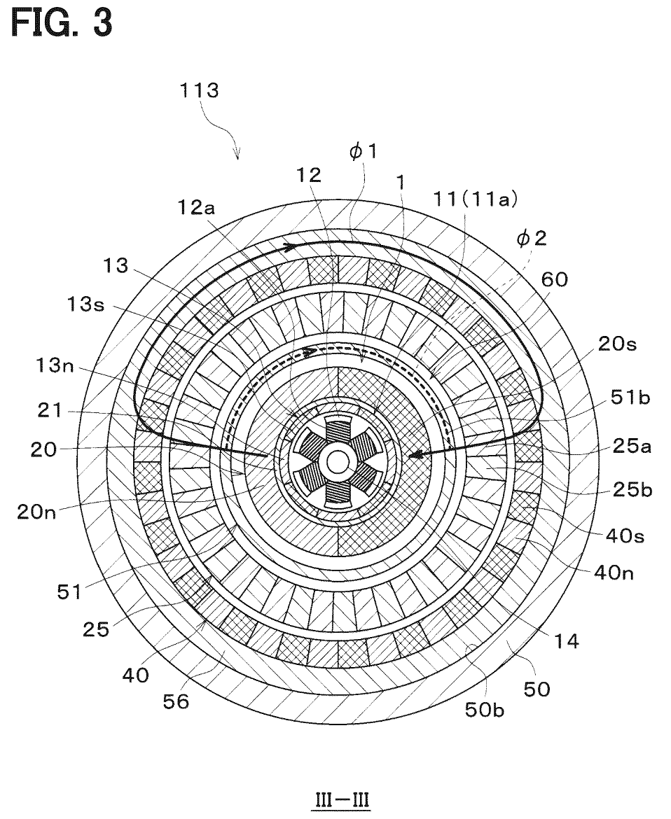

The rotor 13 is cylindrical and the stator 12 is located inside the rotor 13. As shown in FIG. 3, the rotor 13 has a plurality of pairs of magnets consisting of an N pole 13n and an S pole 13s arranged along a circumferential direction. In the present embodiment, there are four each of N poles 13n and S poles 13s, so the number of poles Pr in the rotor 13 is eight. The stator 12 and the rotor 13 output the driving force to rotate the shaft 14 by electromagnetic force.

The motor case 15 has a shaft alignment portion 15a for aligning (so-called centering) the shaft 14 of the drive-mechanism section 10 and a rotating member 41 of the driven-mechanism section 35. The shaft alignment portion 15a is fitted to a body 50 of the driven-mechanism section 35.

The circuit section 70 is housed in the motor case 15. The circuit section 70 has a circuit board with multiple electronic components for controlling the motor 11.

The driven-mechanism section 35 includes the rotating member 41, the valve body 48, a bearing 49, and the body 50.

The rotating member 41, the valve body 48, and the bearing 49 are housed in the body 50. The body 50, together with the motor case 15, constitutes a housing of the first expansion valve 113. The body 50 has a valve chamber 52, an inlet connection port 53, an outlet connection port 54, and a valve seat 55. The body 50 is a valve port forming member that forms a valve port 52a of the valve chamber 52.

The rotating member 41 is an output shaft of the power transmission device 1 and rotates by the driving force transmitted from the drive-mechanism section 10. The rotating member 41 is a rod-shaped member and is coaxially disposed with the shaft 14. An engagement groove 41a is formed in an end of the rotating member 41 opposite the drive-mechanism section 10. The rotating member 41 is rotatably supported by the bearing 49 fixed to the body 50.

The valve body 48 is a rod-shaped member located in the valve chamber 52. The valve body 48 is coaxially disposed with the rotating member 41. A protruding piece 48a of the valve body 48 engages the engagement groove 41a of the rotating member 41. As a result, the rotational force of the rotating member 41 is transmitted to the valve body 48.

The protruding piece 48a is formed at one end of the valve body 48. An outer surface of the valve body 48 has a male screw. The male screw of the valve body 48 are screwed into a screw hole 50a formed in the body 50, constituting a screw mechanism. As a result, the valve body 48 moves axially as the valve body 48 rotates.

The valve body 48 includes multiple members. More specifically, the valve body 48 includes a male screw member 481, which is located closer to the rotating member 41 and formed with the male screw, a valve seat member 482, which is located closer to the valve seat 55 side, and a ball 483 disposed between the two members 481, 482. With the ball 483 positioned between the two members 481, 482, the valve seat member 482 of the valve body 48 moves axially without rotation.

The valve seat member 482 being a ball receiving member in the valve body 48 is biased by a coil spring 47 to a side in which the valve body 48 is axially away from the valve seat 55.

The valve body 48 moves in the axial direction, causing the valve body 48 to contact or move away from the valve seat 55, opening or closing the valve port 52a of the valve chamber 52. In the valve chamber 52, as the valve body 48 leaves the valve seat 55, the refrigerant flows from the inlet connection port 53 to the outlet connection port 54 through the valve port 52a to reduce pressure and expansion.

The power transmission device 1 includes a non-contact coupling portion 60. The non-contact coupling portion 60 has a magnetic gear 60b and a partition wall 51. The magnetic gear 60b has a drive magnet 20, a pole piece 25 and a fixed magnet 40.

The drive magnet 20 is an input shaft magnet that rotates together with the shaft 14 of the motor 11. The pole piece 25 is a magnetic modulator that modulates magnetic flux between the drive magnet 20 and the fixed magnet 40, and rotates together with the rotating member 41. The fixed magnet 40 is fixed to the body 50 of the first expansion valve 113.

The drive magnet 20 is cylindrical and is joined to an outer surface of the rotor 13 of the motor 11 via a cylindrical intervening member 21. In other words, the motor 11 is located inside the drive magnet 20. The intervening member 21 is formed of magnetic material.

The drive magnet 20 has at least one pair of magnets consisting of an N pole 20n and an S pole 20s arranged along a circumferential direction. In the present embodiment, there is one N pole 20n and one S pole 20s each, so the number of poles Pin of the drive magnet 20 is two.

The number of poles Pin of the drive magnet 20 is the same as the number of poles Pr of the rotor 13 minus the number of slots Ns of the stator 12. In the present embodiment, the number of poles Pr of the rotor 13 is eight and the number of slots Ns of the stator 12 is six, so the number of poles Pin of the drive magnet 20 is two.

The partition wall 51 is a sealing member that divides an internal space of the first expansion valve 113 into a drive space 113a and a driven space 113b, and seals the driven space 113b. The drive space 113a is a space in the drive-mechanism section 10, and the driven space 113b is a space in the driven-mechanism section 35.

The partition wall 51 prevents refrigerant (high-pressure refrigerant) in the driven space 113b from leaking into the drive space 113a. In this example, the partition wall 51 is a member with a predetermined magnetic permeability. For example, the partition wall 51 is made of austenitic stainless steel such as SUS 305, which is transformed to martensite by work hardening to give it magnetic properties.

The partition wall 51 is coupled to the body 50. The partition wall 51 and the body 50 form a pressure vessel which is resistant to pressure.

The partition wall 51 is disk-shaped with a middle portion concave downward and has a sealing top portion 51a, a sealing cylindrical portion 51b, and a sealing bottom portion 51c. The sealing top portion 51a is a circular plate and its outer edge is fixed to the body 50 of the first expansion valve 113. The sealing cylindrical portion 51b is cylindrical and located closer to an outer diameter of the drive magnet 20. The sealing bottom portion 51c is located below the drive magnet 20 and seals the sealing cylindrical portion 51b from the drive space 113a.

The sealing bottom portion 51c is disk-shaped with a middle portion curved downward. A corner that form a boundary between the sealing cylindrical portion 51b and the sealing bottom portion 51c are not right-angled, but rounded with a predetermined radius of curvature to enhance its pressure resistance.

To improve the pressure resistance of the partition wall 51, the sealing top portion 51a, the sealing cylindrical portion 51b, and the sealing bottom portion 51c are integrally molded.

The sealing bottom portion 51c is located in a gap between the shaft 14 and the rotating member 41 in the axial direction of the shaft 14 and the rotating member 41. In other words, the sealing bottom portion 51c is located at a location with few torque generation points. This makes it easier to ensure torque and pressure resistance in the partition wall 51.

The pole piece 25 is cylindrical and is located closer to an outer surface of the sealing cylindrical portion 51b of the partition wall 51. The pole piece 25 is joined to the rotating member 41 of the driven-mechanism section 35.

The fixed magnet 40 is cylindrical and is located closer to an outer surface of the pole piece 25. The fixed magnet 40 is fitted into a cylindrical body cylindrical portion 50b (in other words, a housing cylindrical portion) of the body 50 (in other words, the housing) via a cylindrical back yoke 56. The back yoke 56 and the body cylindrical portion 50b are formed of magnetic material.

The fixed magnet 40 has a pair of magnets consisting of N pole 40n and S pole 40s, arranged at equal intervals along the circumferential direction. The number of poles Pf of the fixed magnet 40 is more than the number of poles Pin of the drive magnet 20. In the present embodiment, the number of poles Pf of the fixed magnet 40 is forty, since there are twenty N poles 40n and twenty S poles 40s. The fixed magnet 40 is a multi-pole magnet with more poles than the drive magnet 20.

The pole piece 25 has magnetic sections 25a and non-magnetic sections 25b. The magnetic sections 25a and the non-magnetic sections 25b are fan-shaped, and the magnetic sections 25a are arranged at equal intervals along the circumferential direction. One of the non-magnetic sections 25b is located between the magnetic sections 25a. For example, the magnetic sections 25a are formed of soft magnetic material (for example, iron-based metal), and the non-magnetic sections 25b are formed of non-magnetic material (for example, stainless steel or resin).

The number of poles Pp of pole pieces 25 is the same as the sum of the number of poles Pin of the drive magnet 20 and the number of poles Pf of the fixed magnet 40. In the present embodiment, the number of poles Pin of the drive magnet 20 is two and the number of poles Pf of the fixed magnet 40 is forty, so the number of poles Pp of the pole piece 25 is forty two. That is, the magnetic sections 25a are 21, and the non-magnetic sections 25b are 21. In other words, the number Npp of the magnetic sections 25a has the following relationship to the number of poles Pin of the drive magnet 20 and the number of poles Pf of the fixed magnet 40.

$$Npp = ( Pin + P f ) / 2$$

An axial length of the pole piece 25 is shorter than an axial length of the fixed magnet 40. As a result, flux leakage in the axial direction at the pole piece 25 can be reduced and the transmission torque can be improved.

Since a configuration of the second expansion valve 115 is similar to that of the first expansion valve 113, a detailed configuration description of the second expansion valve 115 is omitted.

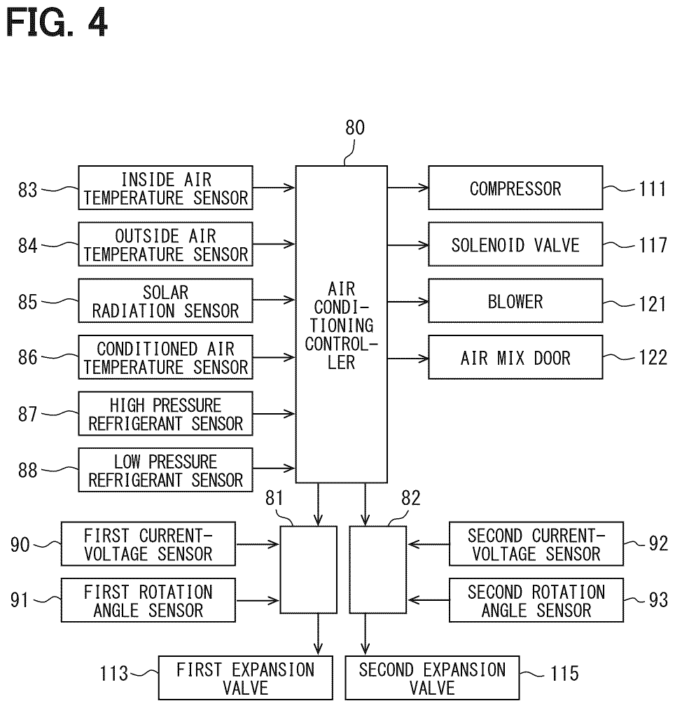

Next, the outline of a controller of the present embodiment will be described. The air conditioning controller 80, a first expansion valve controller 81, and a second expansion valve controller 82 shown in FIG. 4 are electronic control units with well-known microcontrollers including a central processing device (i.e., CPU), a read only memory (i.e., ROM), a random access memory (i.e., RAM), and peripheral circuits. The air conditioning controller 80, the first expansion valve controller 81, and the second expansion valve controller 82 perform various calculations and processing based on a control program stored in the ROM, and control operation of various control target devices connected to an output side.

The first expansion valve controller 81 and the second expansion valve controller 82 are connected to the air conditioning controller 80 via a harness to communicate with each other. Therefore, based on detection or operation signals input to one controller, the operation of the controlled equipment connected to the output side of the other controller can be controlled.

The air conditioning controller 80 controls the operation of the compressor 111 of the vapor compression refrigeration cycle 110, the solenoid valve 117, the blower 121 of the air conditioning unit 120, and actuators for driving the air mix door 122.

The first expansion valve controller 81 controls the operation of the first expansion valve 113 of the refrigeration cycle 110. More specifically, the first expansion valve controller 81 calculates a value of a driving current to be output to the motor 11, and outputs the driving current to the motor 11 based on the calculation result. The first expansion valve controller 81 is composed of the circuit section 70 of the first expansion valve 113.

The second expansion valve controller 82 controls the operation of the second expansion valve 115 of the vapor compression refrigeration cycle 110. More specifically, the second expansion valve controller 82 calculates a value of a driving current to be output to the motor 11, and outputs the driving current to the motor 11 based on the calculation result. The second expansion valve controller 82 is composed of the circuit section 70 of the second expansion valve 115.

A group of control sensors, including an inside air temperature sensor 83, an outside air temperature sensor 84, a solar radiation sensor 85, a conditioned air temperature sensor 86, a high pressure refrigerant sensor 87, and a low pressure refrigerant sensor 88, are connected to the input side of the air conditioning controller 80. Detection signals of the group of control sensors for air conditioning control are input to the air conditioning controller 80. These sensors are included in components that make up the refrigeration cycle.

The inside air temperature sensor 83 is an inside-air temperature detector that detects an inside air temperature Tr that is a temperature in the vehicle compartment. The outside air temperature sensor 84 is an outside-air temperature detector that detects an outside air temperature Tam that is a temperature outside the vehicle compartment. The solar radiation sensor 85 is a solar radiation amount detection unit which detects a solar radiation amount as irradiated into the vehicle compartment. The conditioned air temperature sensor 86 is an air-conditioning air temperature detector that detects a temperature TAV of an air-conditioning air blown into the vehicle compartment from the air conditioning unit 120.

The high pressure refrigerant sensor 87 is a high pressure side refrigerant detector that detects a pressure and temperature of a high pressure side refrigerant of the vapor compression refrigeration cycle 110. The low pressure refrigerant sensor 88 is a low pressure side refrigerant detector that detects a pressure and temperature of the low pressure side refrigerant of the vapor compression refrigeration cycle 110.

Various operation switches on an air conditioning operation panel are also connected to the input side of the air conditioning controller 80. The air conditioning operation panel is disposed near an instrument panel in a front part of the vehicle compartment. The instrument panel is located at the front of the vehicle compartment, near the front of a driver's seat. The instrument panel displays various information such as traveling speed of the electric vehicle and the operating status of the electric vehicle. The instrument panel warns occupants by display and sound when there is an abnormality or malfunction in various devices of the electric vehicle.

Operation signals output from the various operation switches of the air conditioning operation panel are input to the air conditioning controller 80. Specific examples of the various operation switches provided on the air conditioning operation panel include an auto switch, an air conditioner switch, an air volume setting switch, and a temperature setting switch.

The auto switch is an operation unit for the occupants to set or cancel the automatic control operation of the air conditioning in the vehicle compartment. The air conditioner switch is an operation unit for the occupants to request cooling of the air in the in the vehicle compartment. The air volume setting switch is an operation unit for the occupants to manually set the air volume of the blower 121. The temperature setting switch is an operation unit that allows the occupants to set a set temperature Tset in the vehicle compartment.

A first current-voltage sensor 90 and a first rotation angle sensor 91 are connected to the input side of the first expansion valve controller 81. The first current-voltage sensor 90 is a first expansion valve current-voltage detector that detects an electric current and a voltage supplied to the motor 11 of the first expansion valve 113. The first rotation angle sensor 91 is a first rotation angle detector that detects a rotation angle (in other words, rotation position) of the motor 11 of the first expansion valve 113.

The first current-voltage sensor 90 is attached to the first expansion valve 113. In the first current-voltage sensor 90, a current detector and a voltage detector are integrated, but the current detector and the voltage detector may be constructed separately.

A second current-voltage sensor 92 and a second rotation angle sensor 93 are connected to the input side of the second expansion valve controller 82. The second current-voltage sensor 92 is a second expansion valve current-voltage detector that detects an electric current and a voltage supplied to the motor 11 of the second expansion valve 115. The second rotation angle sensor 93 is a second rotation angle detector that detects a rotation angle (in other words, rotation position) of the motor 11 of the second expansion valve 115.

The second current-voltage sensor 92 is attached to the second expansion valve 115. In the second current-voltage sensor 92, a current detector and a voltage detector are integrated, but the current detector and the voltage detector may be constructed separately.

The following is an overview of operation of the vehicle air-conditioning device 100 in the present embodiment. The air conditioning controller 80 determines whether to execute the cooling mode, the heating mode, or the dehumidifying-heating mode based on detection signals from the group of control sensors, including the inside air temperature sensor 83, the outside air temperature sensor 84, the solar radiation sensor 85, the conditioned air temperature sensor 86, the high pressure refrigerant sensor 87, and the low pressure refrigerant sensor 88.

The air conditioning controller 80 controls opens and closes of the solenoid valve 117, the first expansion valve 113, and the second expansion valve 115 to switch to the determined operating mode.

In the cooling mode, the solenoid valve 117 is closed, the first expansion valve 113 is fully opened without throttling the refrigerant flow, and the second expansion valve 115 is opened to throttle the refrigerant flow. At this time, the air conditioning controller 80 determines a target throttle opening of the second expansion valve 115 based on the detection signals from the group of the control sensors and outputs the determined target throttle opening to the second expansion valve controller 82. The second expansion valve controller 82 controls the second expansion valve 115 so that the opening degree of the second expansion valve 115 becomes the target throttle opening output from the air conditioning controller 80.

In the heating mode, the solenoid valve 117 is opened, the first expansion valve 113 is opened to throttle the refrigerant flow, and the second expansion valve 115 is closed to shut off the refrigerant flow. At this time, the air conditioning controller 80 determines a target throttle opening of the first expansion valve 113 based on the detection signals from the group of the control sensors and outputs the determined target throttle opening to the first expansion valve controller 81. The first expansion valve controller 81 controls the first expansion valve 113 so that the opening degree of the first expansion valve 113 becomes the target throttle opening output from the air conditioning controller 80.

In the dehumidifying-heating mode, the solenoid valve 117 is closed, and the first expansion valve 113 and the second expansion valve 115 are set to valve openings that throttle the refrigerant flow. The air conditioning controller 80 determines the target throttle opening of the first expansion valve 113 and the target throttle opening of the second expansion valve 115 based on the detection signals from the group of control sensors, and outputs the determined target throttle opening to the first expansion valve controller 81 and the second expansion valve controller 82. The first expansion valve controller 81 controls the first expansion valve 113 so that the opening degree of the first expansion valve 113 becomes the target throttle opening output from the air conditioning controller 80. The second expansion valve controller 82 controls the second expansion valve 115 so that the opening degree of the second expansion valve 115 becomes the target throttle opening output from the air conditioning controller 80.

The operation of the first expansion valve 113 in the present embodiment is described next. Since an operation of the second expansion valve 115 is similar to that of the first expansion valve 113, an explanation of the operation of the second expansion valve 115 is omitted.

The rotor 13 of the motor 11 rotates and the shaft 14 of the motor 11 also rotates together when the driving current is output from the first expansion valve controller 81 to the motor 11 of the first expansion valve 113. When the shaft 14 of the motor 11 rotates and the drive magnet 20 also rotates together, magnetic interaction between the drive magnet 20 and the fixed magnet 40 causes the pole piece 25 to rotate in the same direction as the rotation direction of the drive magnet 20.

A speed reduction ratio is equal to the number of poles of the pole piece 25, Pp, divided by the number of poles Pin of the drive magnet 20. Since the pole number Pp of the pole piece 25 is larger than the pole number Pin of the drive magnet 20, the rotation speed of the pole piece 25 is smaller than that of the drive magnet 20.

In the present embodiment, the number of poles Pp of the pole piece 25 is 42 and the number of poles Pin of the drive magnet 20 is 2, and therefore the speed reduction ratio is 21.

Contrary to this, in a configuration in which the pole piece 25 is fixed and a magnet having the number of poles same as that of the fixed magnet 40 is joined to the rotating member 41 of the driven-mechanism section 35 to rotate (hereinafter, the configuration is referred to as a comparative example), the speed reduction ratio is 20.

Since the number of poles Pp of the pole piece 25 is larger than the number of poles Pf of the fixed magnet 40, in the present embodiment in which the pole piece 25 is rotated, the speed reduction ratio is larger than that of the comparative example in which the magnet having the number of poles same as that of the fixed magnet 40 is rotated.

In the present embodiment, in which the pole piece 25 is rotated, the pole piece 25 is an independent member from the partition wall 51. Therefore, the pressure resistance of the partition wall 51 can be improved compared to a structure in which a pole piece does not rotate and is buried in a sealing plate.

The partition wall 51 has the sealing cylindrical portion 51b and the sealing bottom portion 51c, which gives it a disk shape with its center portion concave toward the driven-mechanism section 35. Therefore, the partition wall 51 can be arranged as an independent component from the pole piece 25, which increases the pressure resistance of the partition wall 51.

The number Npp of the magnetic sections 25a having the pole piece 25 has a following relationship to the number of poles Pin of the drive magnet 20 and the number of poles Pf of the fixed magnet 40.

$$Npp = ( Pin + P f ) / 2$$

This allows the rotational force of the drive magnet 20 to be transmitted to the pole piece 25. The rotational force of the drive magnet 20 is transmitted to the pole piece 25, which rotates the rotating member 41, the output shaft of the power transmission device 1, and the rotational force of the rotating member 41 is transmitted to the valve body 48, which moves in the axial direction. The valve body 48 moves in the axial direction to open and close the valve port 52a of the valve chamber 52, thereby adjusting a flow rate of the refrigerant passing through the valve port 52a.

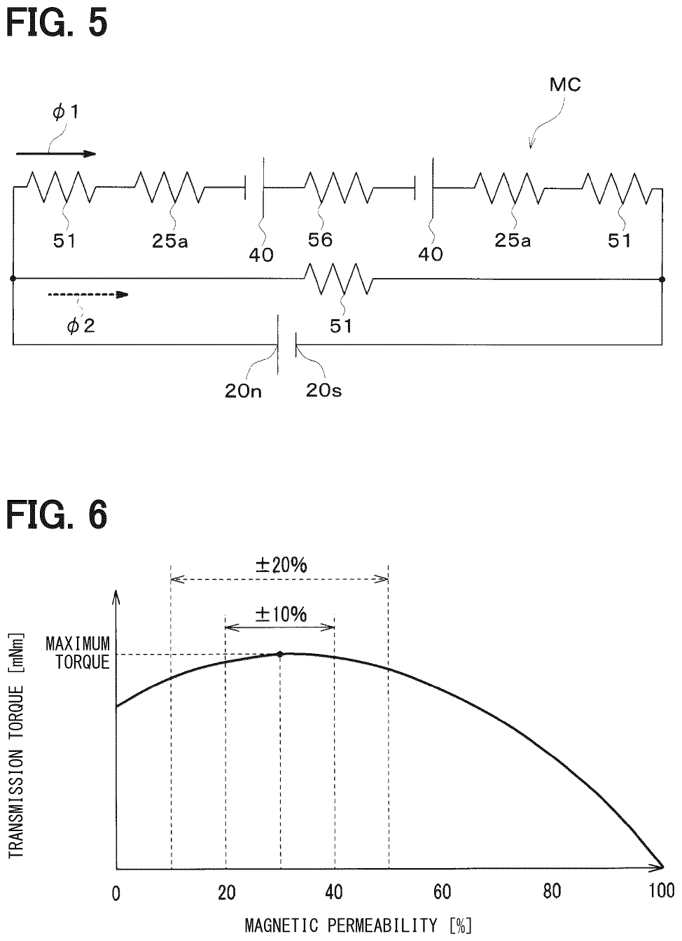

In the non-contact coupling portion 60, a magnetic circuit MC is formed in which magnetic fluxes flow in parallel as shown in FIG. 5, due to magnetism imparted to the partition wall 51. In other words, a torque generation path φ1 shown by a solid arrow in FIGS. 3, 5 and a short-circuit flux path φ2 shown by a dashed arrow in FIGS. 3, 5 are formed as the paths through which the magnetic fluxes flows.

In the torque generation path φ1, the magnetic fluxes flow in the order of the N pole 20n of the drive magnet 20, the partition wall 51, the magnetic section 25a of the pole piece 25, the fixed magnet 40, the back yoke 56, the fixed magnet 40, the magnetic section 25a of the pole piece 25, the partition wall 51, and the S pole 20s of the drive magnet 20. In the short-circuit flux path φ2, the magnetic fluxes flow in the order of the N pole 20n of the drive magnet 20, the partition wall 51, and the S pole 20s of the drive magnet 20.

The magnetic fluxes that contribute to torque generation between the pole piece 25 and the fixed magnet 40 flow in the torque generation path φ1. In the short-circuit flux path φ2, the magnetic fluxes flow in a short circuit without contributing to the torque generation.

FIG. 6 shows a relationship between the magnetic permeability of the partition wall 51 and the torque generated between the pole piece 25 and the fixed magnet 40 (hereinafter referred to as transmission torque). The magnetic permeability of the partition wall 51 is between that of a vacuum and that of iron, specifically in a range of approximately 1.0 μH/m to 6.3 μH/m. A graph in FIG. 6 is convex at a top, and the transfer torque is maximum when the magnetic permeability is at a given value (about 30% in an example in FIG. 6).

In a low permeability region, the transfer torque increases as the permeability of the partition wall 51 increases. This is because more magnetic flux penetrates the partition wall 51 and more magnetic flux flows through the torque generation path φ1. On the other hand, in a high permeability region, the transmission torque decreases as the permeability of the partition wall 51 increases. This is because the magnetic flux flowing through the short-circuit flux path φ2 is significantly increased and the magnetic flux flowing through the torque generation path φ1 is decreased.

Based on the above, the magnetic permeability of the partition wall 51 may be a value within ±20% difference (about 10% to 50% in the example of FIG. 6) from the magnetic permeability (about 30% in the example of FIG. 6) at which the transmission torque is maximum, since a large transmission torque can be generated. The magnetic permeability of the partition wall 51 is more preferable because it can generate almost maximum torque if a difference between the magnetic permeability of the partition wall 51 and the magnetic permeability at which the transmission torque is maximum is within ±10% (about 20% to about 40% in the example of FIG. 6).

To give the desired magnetic permeability to the partition wall 51, the partition wall 51 is made of austenitic stainless steel such as SUS 305, which is transformed to martensite by work hardening to give it magnetic properties. This improves the pressure resistance of the partition wall 51.

In the present embodiment, the magnetic circuit MC is provided in which the magnetic flux from the drive magnet 20 flows in parallel, and the magnetic circuit MC forms the torque generation path φ1 and the short-circuit flux path φ2. In the torque generation path φ1, the magnetic flux flows from the N pole 20n of the drive magnet 20 through the pole piece 25 and the fixed magnet 40 to the S pole 20s of the drive magnet 20 to generate torque. In the short-circuit flux path φ2, the magnetic flux short-circuits and flows from the N pole 20n of the drive magnet 20 to the S pole 20s of the drive magnet 20 without going through the pole piece 25.

According to this, the magnetic flux flowing through the torque generation path φ1 can be increased by forming the short-circuit flux path φ2. This makes it possible to improve the transmission torque.

In the present embodiment, the partition wall 51 is placed between the drive magnet 20 and the pole piece 25 and has a permeability higher than that of a vacuum to form the short-circuit flux path φ2. This allows a good formation of the short-circuit flux path φ2.

In the present embodiment, the magnetic permeability of the partition wall 51 is between that of a vacuum and that of iron. More specifically, the magnetic permeability of the partition wall 51 is within ±20% difference from the magnetic permeability that maximizes torque. More specifically, the magnetic permeability of the partition wall 51 is within ±10% difference from the magnetic permeability that maximizes torque.

As a result, an amount of the magnetic flux flowing through the torque generation path φ1 can be adjusted appropriately and an amount of magnetic flux flowing through the torque generation path φ1 can be increased, thereby improving the transmission torque.

In the present embodiment, the partition wall 51 is made of austenitic stainless steel with martensite. As a result, the partition wall 51 can be easily formed with appropriate magnetic permeability and strength of the partition wall 51 can be increased.

In the present embodiment, the partition wall 51 divides the drive space 113a, which is the space on the drive magnet 20 side, and the driven space 113b, which is the space on the pole piece 25 side. As a result, the number of components can be reduced compared to a case where the component forming the short-circuit flux path φ2 is a separate component from the partition wall 51.

In the present embodiment, the partition wall 51 forms a part of the pressure vessel which seals the driven space 113b so that the pressure vessel is pressure-resistant. As a result, the number of components can be reduced compared to a case where the component forming the short-circuit flux path φ2 is a separate component from the pressure vessel.

### Second Embodiment

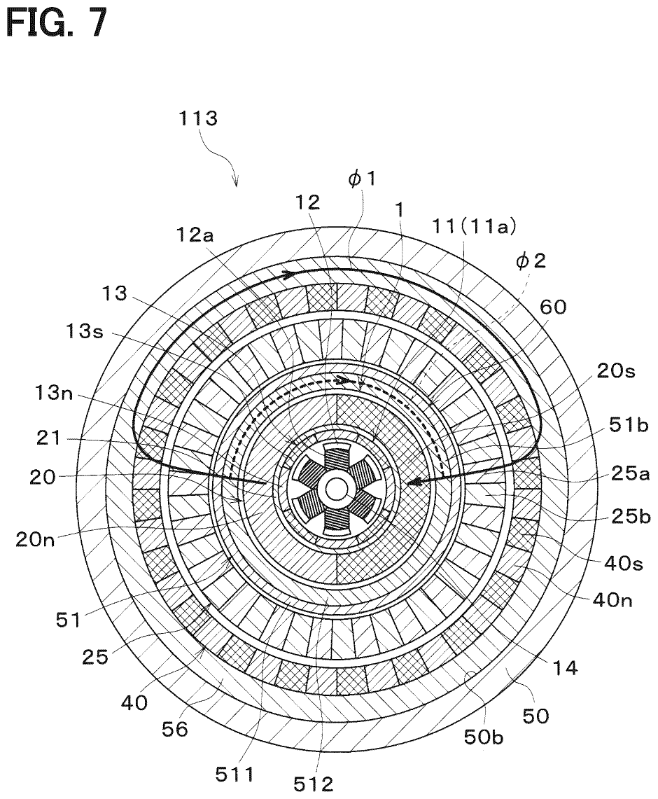

In the first embodiment above, the partition wall 51 is formed of austenitic stainless steel such as SUS305, which is transformed to martensitic by work hardening to give it magnetism, but in a second embodiment, as shown in FIG. 7, a partition wall 51 is formed by stacking a non-magnetic layer 511 and a magnetic layer 512.

The non-magnetic layer 511 is made of non-magnetic material. The magnetic layer 512 is made of magnetic material. The permeability of the partition wall 51 can be set appropriately by setting a ratio of the non-magnetic layer 511 to the magnetic layer 512 appropriately. Also in the present embodiment, actions and effects similar to those of the first embodiment can be obtained.

In the present embodiment, the partition wall 51 is formed by layers, non-magnetic layers 511 and magnetic layers 512, of which the magnetic layers 512 are the magnetic body. As a result, the partition wall 51 can be easily formed with the appropriate permeability.

### Third Embodiment

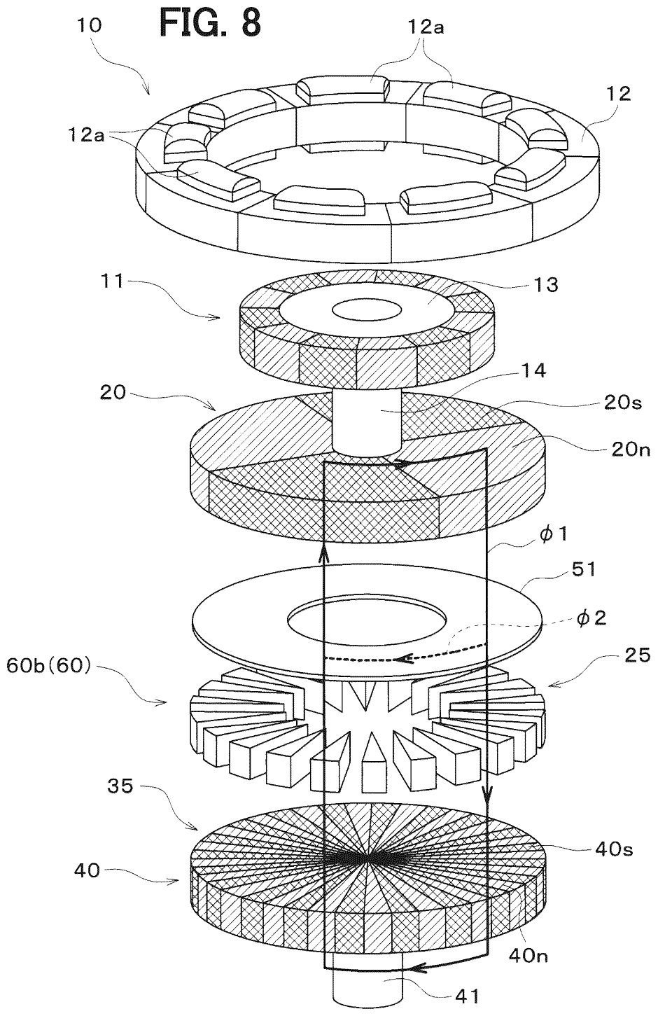

The magnetic gear 60b of the first embodiment above is a radial type magnetic gear 60b in which the drive magnet 20, the pole piece 25, and the fixed magnet 40 are stacked in the radial direction, while a magnetic gear 60b of a third embodiment, as shown in FIG. 8, is an axial type magnetic gear 60b in which a drive magnet 20, a pole piece 25, and a fixed magnet 40 are axially stacked in the axial direction.

In the present embodiment, as in the first embodiment above, a magnetic circuit MC is formed with a torque generation path φ1 and a short-circuit flux path φ2 parallel to each other, so that a large transmission torque can be generated by having a desired magnetic permeability in a partition wall 51.

### Fourth Embodiment

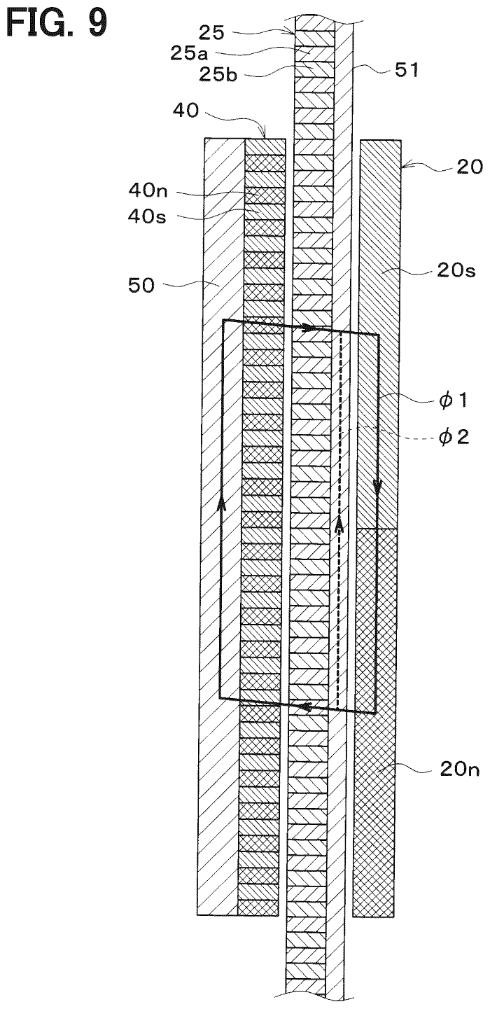

The magnetic gear 60b of the first embodiment above is a radial type magnetic gear 60b in which the drive magnet 20, the pole piece 25, and the fixed magnet 40 are stacked in the radial direction, but a magnetic gear 60b of a fourth embodiment, as shown in FIG. 9, is a linear type magnetic gear 60b in which a drive magnet 20, a pole piece 25, and a fixed magnet 40 are formed as long plates and stacked opposite to each other.

In the present embodiment, as in the first embodiment above, a magnetic circuit MC is formed with a torque generation path φ1 and a short-circuit flux path φ2 parallel to each other, so that a large transmission torque can be generated by having a desired magnetic permeability in a partition wall 51.

The present disclosure is not limited to the above-described embodiments, and can be variously modified as follows within the scope that does not deviate from the gist of the present disclosure.

In the first embodiment above, the partition wall 51 is formed of austenitic stainless steel such as SUS305, which is transformed into martensite by work hardening to give it magnetism, but the partition wall 51 may be formed of magnetic metal with reduced magnetic permeability, achieved by distorting magnetic metal such as electromagnetic steel sheet. The partition wall 51 may be formed of resin mixed with iron powder.

In the first embodiment above, the pole piece 25 and the fixed magnet 40 are arranged outside of the drive magnet 20 in the radial direction, but a pole piece 25 and a fixed magnet 40 may be arranged inside of a drive magnet 20 in a radial direction.

The above embodiment shows an example in which the present disclosure is applied to an expansion valve of a vapor compression refrigeration cycle, but it is not limited to expansion valves and can be applied to various electric valves which open and close a valve orifice through which fluid passes using a valve body of a motor-operated valve. The present disclosure can be applied not only to motor-operated valves but also to power transmission devices that transmit power from various drive devices to various driven devices.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A power transmission device comprising:
a magnetic gear including an input shaft magnet to which rotational driving force is input, a magnetic modulator configured to modulate magnetic flux, a multi-pole magnet having more poles than the input shaft magnet, and an output shaft which rotates together with either the magnetic modulator or the multi-pole magnet;
a magnetic circuit through which the magnetic flux from the input shaft magnet flows in parallel; and
a flux-forming member arranged between the input shaft magnet and the magnetic modulator, having a magnetic permeability higher than a magnetic permeability of a vacuum, and forming a short-circuiting flux path, wherein
the magnetic circuit forms:
a torque generation path for generating torque, in which the magnetic flux flows from an N pole of the input shaft magnet to an S pole of the input shaft magnet via the magnetic modulator and the multi-pole magnet; and
the short-circuit flux path in which the magnetic flux flows from the N pole of the input shaft magnet to the S pole of the input shaft magnet without passing through the magnetic modulator, and
the magnetic permeability of the flux-forming member is within ±20% of a magnetic permeability at which the torque is maximized.

2. A power transmission device comprising:
a magnetic gear including an input shaft magnet to which rotational driving force is input, a magnetic modulator configured to modulate magnetic flux, a multi-pole magnet having more poles than the input shaft magnet, and an output shaft which rotates together with either the magnetic modulator or the multi-pole magnet;
a magnetic circuit through which the magnetic flux from the input shaft magnet flows in parallel; and
a flux-forming member arranged between the input shaft magnet and the magnetic modulator, having a magnetic permeability higher than a magnetic permeability of a vacuum, and forming a short-circuiting flux path, wherein
the magnetic circuit forms:
a torque generation path for generating torque, in which the magnetic flux flows from an N pole of the input shaft magnet to an S pole of the input shaft magnet via the magnetic modulator and the multi-pole magnet; and
the short-circuit flux path in which the magnetic flux flows from the N pole of the input shaft magnet to the S pole of the input shaft magnet without passing through the magnetic modulator, and
the magnetic permeability of the flux-forming member is within ±10% of a magnetic permeability at which the torque is maximized.

3. A power transmission device comprising:
a magnetic gear including an input shaft magnet to which rotational driving force is input, a magnetic modulator configured to modulate magnetic flux, a multi-pole magnet having more poles than the input shaft magnet, and an output shaft which rotates together with either the magnetic modulator or the multi-pole magnet;
a magnetic circuit through which the magnetic flux from the input shaft magnet flows in parallel; and
a flux-forming member arranged between the input shaft magnet and the magnetic modulator, having a magnetic permeability higher than a magnetic permeability of a vacuum, and forming a short-circuiting flux path, wherein
the magnetic circuit forms:
a torque generation path for generating torque, in which the magnetic flux flows from an N pole of the input shaft magnet to an S pole of the input shaft magnet via the magnetic modulator and the multi-pole magnet; and
the short-circuit flux path in which the magnetic flux flows from the N pole of the input shaft magnet to the S pole of the input shaft magnet without passing through the magnetic modulator, and
the flux-forming member is made of austenitic stainless steel and contains martensite.

4. A power transmission device comprising:
a magnetic gear including an input shaft magnet to which rotational driving force is input, a magnetic modulator configured to modulate magnetic flux, a multi-pole magnet having more poles than the input shaft magnet, and an output shaft which rotates together with either the magnetic modulator or the multi-pole magnet;
a magnetic circuit through which the magnetic flux from the input shaft magnet flows in parallel; and
a flux-forming member arranged between the input shaft magnet and the magnetic modulator, having a magnetic permeability higher than a magnetic permeability of a vacuum, and forming a short-circuiting flux path, wherein
the magnetic circuit forms:
a torque generation path for generating torque, in which the magnetic flux flows from an N pole of the input shaft magnet to an S pole of the input shaft magnet via the magnetic modulator and the multi-pole magnet; and
the short-circuit flux path in which the magnetic flux flows from the N pole of the input shaft magnet to the S pole of the input shaft magnet without passing through the magnetic modulator,
the flux-forming member is a partition wall separating a drive space in which the input shaft magnet is arranged from a driven space in which the magnetic modulator is arranged, and
the flux-forming member forms part of a pressure vessel which seals the driven space to ensure its pressure resistance.

5. The power transmission device according to claim 1, wherein
the magnetic permeability of the flux forming member is between the magnetic permeability of the vacuum and a magnetic permeability of iron.

6. The power transmission device according to claim 3, wherein
the magnetic permeability of the flux-forming member is within ±20% of a magnetic permeability at which the torque is maximized.

7. The power transmission device according to claim 3, wherein
the magnetic permeability of the flux-forming member is within ±10% of a magnetic permeability at which the torque is maximized.

8. The power transmission device according to claim 1, wherein
the flux-forming member is formed by layers, and the layers are partially made of magnetic material.

9. The power transmission device according to claim 1, wherein
the flux-forming member is made of austenitic stainless steel and contains martensite.

10. The power transmission device according to claim 1, wherein
the flux-forming member is a partition wall separating a drive space in which the input shaft magnet is arranged from a driven space in which the magnetic modulator is arranged.

11. The power transmission device according to claim 10, wherein
the flux-forming member forms part of a pressure vessel which seals the driven space to ensure its pressure resistance.
